(19) United States
(12) Patent Application Publication
(10) Pub. No.: US 2020/0352301 A1
(43) Pub. Date: Nov. 12, 2020

(54) CONTAINERS AND METHODS FOR CHARGING PHOSPHORESCENT ITEMS

(71) Applicants: Douglas Leo Blanchard, Livermore, CA (US); Matthew Floyd Christy, West Sacramento, CA (US)

(72) Inventors: Douglas Leo Blanchard, Livermore, CA (US); Matthew Floyd Christy, West Sacramento, CA (US)

(21) Appl. No.: 16/748,600

(22) Filed: Jan. 21, 2020

Related U.S. Application Data
(63) Continuation of application No. PCT/US2019/065093, filed on Dec. 6, 2019.
(60) Provisional application No. 62/973,533, filed on Oct. 10, 2019.
(60) Provisional application No. 62/917,471, filed on Dec. 11, 2018.
(60) Provisional application No. 62/917,360, filed on Dec. 6, 2018.

(51) Int. Cl. A45C 15/06; F21V 23/04; A63B 67/06; A63B 71/00; A63B 43/00; A63B 47/00; A45F 3/02; A01K 15/02

(52) U.S. Cl. CPC A45C 15/06; F21V 23/04; A63B 67/06; A63B 71/0036; F21Y 2115/10; A63B 47/00; A45F 3/02; A01K 15/025; A63B 43/008

(57) ABSTRACT

An apparatus for charging phosphorescent items can include a receptacle portion configured to receive at least one phosphorescent item; a light source formed on an inner surface of the receptacle portion, and configured to emit a charging light to charge the at least one phosphorescent item to emit latent light; a power source; and a switch configured to selectively provide power to the light source. The apparatus is portable for easy transport by a person.

### RELATED APPLICATIONS

This application claims the benefit of Patent Cooperation Treaty International Application No. PCT/US2019/065093 filed 12/06/2019, which claims the benefit of

U.S. provisional patent applications having Ser. No. 62/973,533, filed on Oct. 10, 2019, Ser. No. 62/917,471, filed on Dec. 18, 2018, and Ser. No. 62/917,360, filed on Dec. 6, 2018, the contents all of which are incorporated by reference herein.

### TECHNICAL FIELD

The present disclosure relates generally to devices for charging phosphorescent items, and more particularly to portable containers having lighted enclosures for charging phosphorescent items.

### BACKGROUND

The activities that many people enjoy can be limited by daylight. Often the majority of daytime is occupied by work, chores or other duties. By the time one is free for recreation time, the sun may be setting, or it may already be dark. This can be particularly true at higher latitudes in winter.

Some people do not let low-light or darkness prevent them from doing the things they enjoy, and they pursue activities regardless of lighting conditions. However, playing in the darkness can be dangerous and result in the loss of equipment. To address this, some have proposed illuminated recreational equipment. A drawback to such approaches can be complexity and/or cost of such items. For example, providing a ball or flying disc that is illuminated by a power source can substantially increase the price of the product. Further, such products may suffer in performance, break more easily, or, in the case of pet toys, be dangerous if pieces are consumed by a pet.

Another approach can be the use of phosphorescent (glow-in-the-dark) materials. Glow-in-the-dark materials can be easily incorporated into recreational equipment with little or no loss in performance. Glow-in-the-dark items are “charged” by being exposed to a charging light, and once charged can provide a latent illumination. Eventually, the latent illumination becomes too weak, and the item must be charged again. When used indoors, glow-in-the-dark items can be recharged quickly and effectively, as light sources are readily available. However, the use of glow-in-the-dark items outdoors can be more problematic.

One conventional approach to using glow-in-the-dark items outdoors involves employing a portable light source, such as a flashlight (torch). In particular, a flashlight can be used that emits some or most of its light in the ultraviolet (UV) spectrum, which can the most effective spectrum for most glow-in-the-dark items. A drawback to such an approach can be the awkwardness in having to handle both items (the flashlight and the glow-in-the-dark item). Further, charging in this manner is usually not effective, resulting in relatively short-lived latent light duration or incomplete charging. Still further, cost effective UV light sources can also emit light in the visible spectrum. This can be uncomfortable in low light and dark conditions, ruining any acquired dark vision.

### BRIEF DESCRIPTION OF THE DRAWINGS

FIGS. 1A, 1B and 1C are diagrams showing cross sectional views of a container and corresponding methods according to embodiments.

FIGS. 2A and 2B are diagrams of a bag-type container according to an embodiment.

FIG. 3 is a diagram of a lighting member that can be included in embodiments.

FIGS. 4A and 4B are diagrams of bases that can be included in embodiments.

FIGS. 5A to 5D are diagrams showing power sources and power source connections that can be included in embodiments.

FIGS. 6A to 6C are diagrams of a bag-type container and operations according to embodiments.

FIGS. 7A and 7B are diagrams showing handling members that can be included in embodiments.

FIG. 8 is a diagram of a bag-type container according to a further embodiment.

FIGS. 9A and 9B are diagrams showing a bag-type container according to another embodiment.

FIG. 10 is a diagram of a lighting source configuration according to an embodiment.

FIG. 11 is a diagram of a bag-type container according to another embodiment.

FIGS. 12A to 12I are diagrams of various glow-in-the-dark flying disc containers and operations according to embodiments.

FIGS. 13A and 13B are diagrams of alternative embodiments.

FIG. 14 is a flow diagram of a method according to an embodiment.

FIG. 15 is a flow diagram of a method according to another embodiment.

### DETAILED DESCRIPTION

Embodiments disclosed herein show devices and methods for providing a portable container for fast, efficient charging of phosphorescent (glow-in-the-dark) items. A container can include a receptacle (compartment) for receiving one or more glow-in-the-dark items, having an inner surface with a charging light source. The charging light source can be enabled by a switch to saturate and/or surround the glow-in-the-dark item with charging light.

In some embodiments, a portable container can include an opening that can be closed when the glow-in-the-dark item is placed within. When the opening is closed, light from the charging light source can be substantially prevented from being emitted from the portable container.

In some embodiments, a charging light source can be a set of light emitting diodes (LEDs). In particular embodiments, the LEDs can be ultraviolet (UV) spectrum LEDs.

In some embodiments, a portable container can include a rigid base for enabling the container to be set securely on a surface and not be easily tipped over. In some embodiments, a base can form part of the compartment, and include all or part of the charging light source.

In some embodiments, a switch to control the charging light source can be accessible on an outside of the container, enabling the charging light source to be turned on after the glow-in-the-dark item has been placed in the compartment, and/or turned off before removing the glow-in-the-dark item for the compartment.

In some embodiments, a portable container can include a carrying member to enable it to be transported without having to grasp it by the hand.

In some embodiments, a portable container can include a compartment configured to receive any of: one or more balls, one or more flying discs, one or more pet toys.

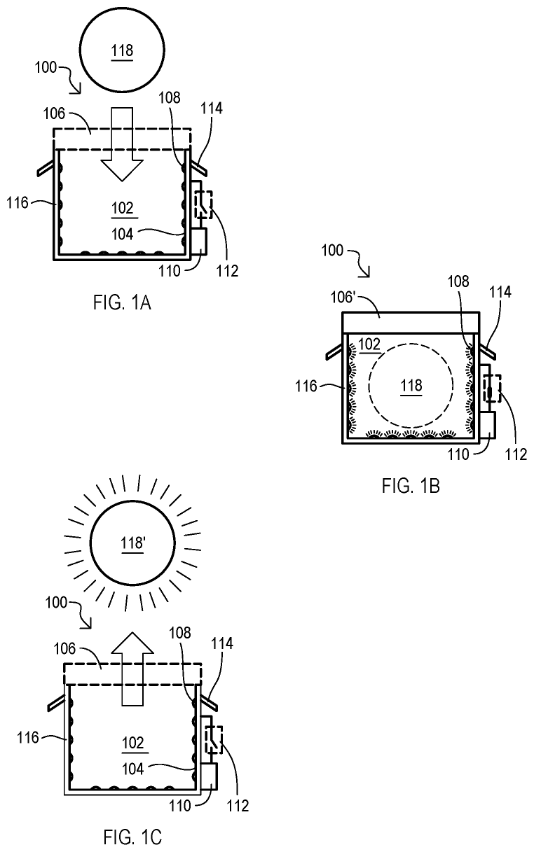

FIGS. 1A to 1C are a series of cross sectional views showing a portable charging container 100 for glow-in-the-dark items according to an embodiment. A container 100 can include a compartment (i.e., receptacle) 102 and an opening 106 (that are both part of a larger body 116), a power source 110, and a switch 112. A compartment 102 can provide a region for receiving a glow-in-the-dark item 118. Compartment 102 can include an inner surface 104 on which can be formed one or more charging light sources (one shown as 108). Charging light sources 108 can be turned on or off via switch 112. In some embodiments, an inner surface 104 can be all or partially reflective with respect to light emitted from charging light source 108.

In some embodiments, an opening 106 can be have an open state and a closed state. In an open state, a glow-in-the-dark item can be placed into compartment 102 through the opening 106. In a closed state, an opening can substantially limit or prevent charging light from being emitted from enclosure to outside of the container. In addition, in the closed state, glow-in-the-dark items being charged can be prevented from inadvertently falling out of, or otherwise escaping, the compartment 102.

In some embodiments, a container 102 can further include one or more handling members 114 that can enable the container to be more easily carried by a person. It is understood that a handling member 114 can take any suitable form, including but not limited to, a strap, an attachment for a strap or similar item, a handle, or a leash, as but only a few examples.

While FIGS. 1A to 1C show charging light sources on opposing surfaces as well as on a bottom surface, this should not be construed as limiting. Alternate embodiments may have no charging light source on a bottom surface or charging light sources on only one surface. Similarly, while power source 110 and switch 112 are shown on an outside of the container 100, either or both such items could be located on an inside of the container 100. However, having switch 112 on an outside of the container can provide an advantageously accessible position for a user.

FIGS. 1A to 1C show a charging operation for a glow-in-the-dark item according to embodiments.

In FIG. 1A, a switch 112 can be in the off position, turning the charging light sources 108 off. Further, opening 106 can be in an open state. This can allow glow-in-the-dark item 118 to be placed into compartment 102 without any charging light being emitted into the environment. Of course, a glow-in-the-dark item 118 could be placed into a compartment 102 with the charging light sources 108 on.

In FIG. 1B, glow-in-the-dark item 118 is in the compartment 102. Further, opening 106′ is in the closed state. With glow-in-the-dark item 118 in the compartment, switch 112 can be placed in the on position, powering charging light sources 108. Glow-in-the-dark item 118 can be saturated with charging light for a fast and effective charging operation. Because opening 106′ is in the closed state, in the event charging light sources 106 emits any light in the visible spectrum, such light is substantially prevented from being emitted out of the container 100.

In FIG. 1C, a charged glow-in-the-dark item 118′ can be removed from the container 100. Opening 106 can be in an open state. In some embodiments, switch 112 can be returned to the off position, turning of charging light sources 108 before charged glow-in-the-dark item 118′ is removed. However, as will be shown for other embodiments herein, some types of openings can automatically return to a closed state as items and inserted to, and/or removed from, a compartment 102.

It is understood that embodiments can include containers of various sizes and materials to accommodate any suitable glow-in-the-dark items. Accordingly, while particular containers will be described below, such embodiments should not be construed as limiting.

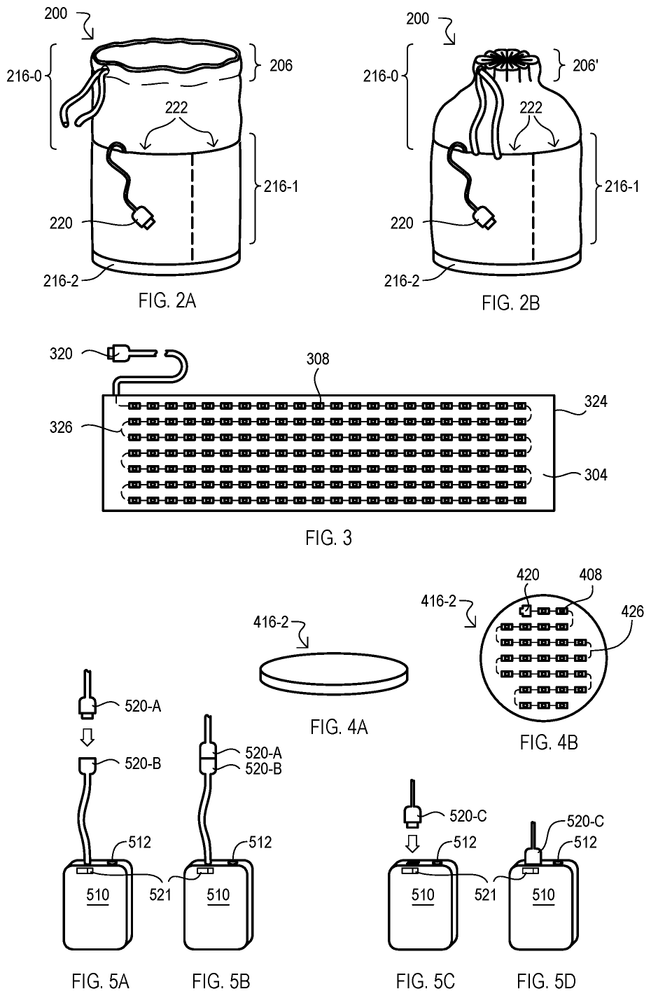

FIGS. 2A and 2B are diagrams showing a first bag-type container 200 according to an embodiment. A container 200 can be one version of that shown in FIGS. 1A to 1C. A container 200 can include a body (216-0 to -2), a closable opening 206, and charging light sources (not shown). In the embodiment shown, a body can include a first portion 216-0, a second portion 216-1 and a base 216-2. A base 216-2 can be formed of a more rigid material than first and/or second portions (216-0/1). In some embodiments, first and second portions 216-0/1 can be formed of any suitable flexible material, such as Kevlar, as but one of numerous examples. First and second portions 216-0/1 can be part of a same overall material, or separate materials joined to one another.

An opening 206 can be a drawstring opening, capable of being placed in an open configuration (shown in FIG. 2A) and a closed configuration 206′ (shown in FIG. 2B).

In the embodiment shown, container 200 can include one or more outside pockets 222 (two shown in FIGS. 2A and 2B). Outside pockets 222 can have fixed openings (as shown) or closable openings. Closable openings can take any suitable form, including but not limited to a flap, a Velcro-type arrangement, zippers, etc.

FIGS. 2A/2B show one pocket 222 with an electrical connection 220. An electrical connection 220 can provide an electrical connection to a charging light source within container 200. An electrical connection 220 can take any suitable form, and in some embodiments can be a Universal Serial Bus (USB) type power connection. In such an arrangement, a power source placed inside a pocket 222 can be connected to electrical connection 220, and thus provide a power source for the charging light sources. Pockets 222 can provide convenient storage locations for various other items. As but one example, if a container 200 is used to charge and store glow-in-the-dark dog toys, pockets 222 can be used to store a leash and/or clean-up bags, as but two of many possible examples.

FIG. 3 is a diagram of a lighting member 324 that can be included in embodiments. A lighting member 324 can contain charging light sources (one shown as 308). A lighting member 324 can form a portion of a container body or be inserted into a compartment of a container. Thus, a lighting member 324 can be made of a flexible material so as to bend to form a container body, and/or conform to the shape of compartment within a container. Thus, a lighting member 324 can thus form part of an inner surface 304 of a charging compartment for a container.

Charging light sources 308 can be an LED ribbon or chain attached to, or otherwise integrated with, the lighting member. In the embodiment shown, charging light sources 308 can be connected in series by a wiring 326 and arranged to cover a surface of lighting member 324. Such an arrangement can help ensure a corresponding compartment is saturated with charging light. In the embodiment shown, a lighting member 324 can include an electrical connection 320. An electrical connection 320 can take any suitable form, including a USB power connection.

FIGS. 4A and 4B show examples of a base 416-2 that can be included in embodiments. A base 416-2 can be formed of a rigid material to enable a container to remain securely on a surface when set down on the surface. In some embodiments, other, more flexible materials can be attached to a base 416-2 to form a body of a container. While FIGS. 4A and 4B show a base having a circular shape, a base can take an shape suitable to its corresponding container. A container shape can correspond to the shape(s) of glow-in-the-dark item(s) to be charged.

In some embodiments, as shown in FIG. 4B, a base 416-2 can have lighting sources 408 formed therein. Thus, such a base 416-2 can form part of a charging compartment. However, alternate embodiments may not include any lighting on a base. In some embodiments, lighting sources 408 can be recessed within a surface of a base and/or covered with a transparent material for protection. While FIG. 4B shows a base with an LED chain arrangement, including multiple lighting sources 408 connected by a writing 426, alternate embodiments may include other suitable lighting source, including a single light source.

FIGS. 5A to 5D show examples of power sources 510 and connections that can be included in embodiments. FIGS. 5A and 5B show an arrangement in which a power source 510 can have a power connector 520-B that can connect to a light source connector 520-A. FIGS. 5C and 5D show an arrangement in which a light source connector 520-C can connect directly to a power source 510. A power source 510 can have a switch 512 which can control power to a connected lighting source. In other embodiments there can be a direct wiring from a power supply to a charging light source (i.e., there are no connectors).

A power source 510 can take any suitable form, and in some embodiments can be a battery pack which can hold on one or more primary or secondary (i.e., rechargeable) batteries. Such batteries can be removable from the power source 510 and/or built into the power source. A power source 510 can be a size suitable to be securely carried on or in a container. For example, a power source 510 can be sized to fit in a pocket (e.g., 222 of FIGS. 2A/B) of a container, or even within a charging compartment of a container. In some embodiments, a power source 510 can be a waterproof or water resistance assembly.

In some embodiments, a power source 510 can include one or more indicators 521. An indicator 521 can indicate various conditions of the power source, including but not limited to: when power is or is not being provided to a charging light source, how much power remains, how long a glow-in-the-dark item has been charging, or how long until a glow-in-the-dark item is considered fully charged. An indicator 521 can take any suitable form, including visual, audio, or tactile (e.g., vibration).

In some embodiments, a power source 510 can have an automatic power feature. That is, in response to predetermined conditions, a power source may automatically turn on or off. As but a few of many possible examples, a power source 510 may: automatically turn off after a predetermined time period; automatically turn on if a charging chamber sensor indicates no, or low light levels (i.e., a glow-in-the-dark item in the chamber needs charging); remain off if a charging chamber sensor indicates high enough light levels (i.e., a glow-in-the-dark item in the chamber is charged and so does not need to be lighted).

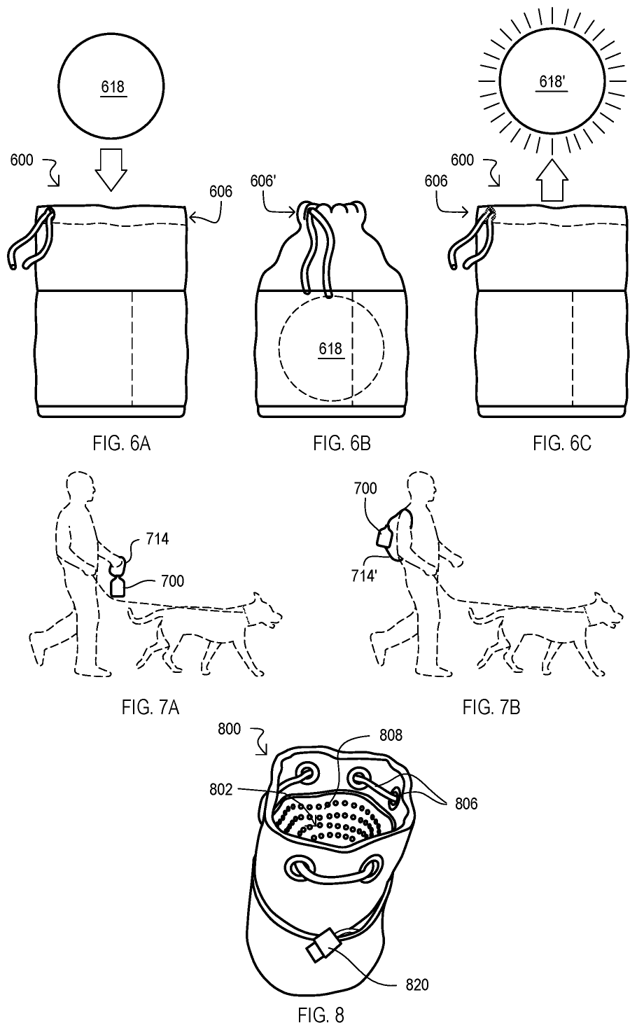

FIGS. 6A to 6C show a portable charging container 600 and operation according to an embodiment. A container 600 can be one example of those shown in FIGS. 1A to 1C or 2A/B.

Referring to FIG. 6A, a container 600 can have an opening 606 in an open state. This can allow a glow-in-the-dark ball 618 to be placed into a charging chamber (not shown) formed within. Referring to FIG. 6B, once glow-in-the-dark ball 618 is within a charging chamber, an opening 606′ can be closed (in this embodiment, cinched shut). If not already on, charging light source(s) (not shown) can be turned on to charge the glow-in-the-dark ball 618.

Referring to FIG. 6C, after some time, a charging operation can result in a charged glow-in-the-dark ball 618′. The opening 606 can opened, allowing luminous glow-in-the-dark ball 618′ to be removed and used. In some embodiments, a container 600 can be pet toy container for storing and charging a glow-in-the-dark pet toy, such as a glow-in-the-dark ball.

As noted herein, in some embodiments a container can include a handling member for ease of transport. FIGS. 7A and 7B show examples of handling members but should not be construed as limiting. FIG. 7A shows a container 700 with a small band or tie-type handling member 714. Such a handling member can include one or more relatively small loops that can enable a container 700 to be carried by hand or wrapped around a wrist, for example. FIG. 7B shows a container 700 with a larger shoulder strap-type handling member 714′. Handling members 714/714′ can be adjustable. Further, handling members 714/714′ can form part of, or be separate from an opening of a container 700.

FIG. 8 is a top perspective view of a container 800 according to another embodiment. A container 800 can be a pet toy container for storing and charging glow-in-the-dark pet toys. A container 800 can include an internal chamber 802 having an inner surface with charging light sources (e.g., 808) formed thereon. A container 800 can have a bag-type shape, with a drawstring opening 806. Charging light sources 808 can be powered via an electrical connection 820, which in some embodiments can be a USB power connection. A container 800 can include a rigid base (not shown). In some embodiments, container 800 can be one version of any of those shown in FIGS. 2A/B and/or 6A to 7B.

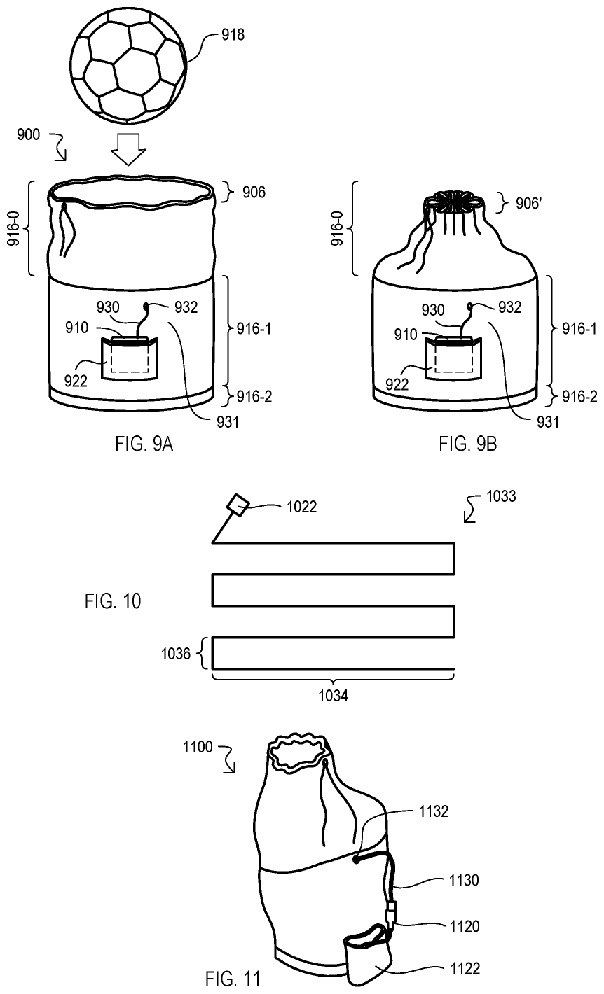

FIGS. 9A and 9B are diagrams showing a second bag-type container 900 according to an embodiment. A container 900 can be one version of that shown in FIGS. 1A to 1C. A container 900 can include items like those of FIGS. 2A/B, including a body (916-0 to -2), a closable opening 906, and a charging light source (not shown). Such features can vary in the same manner as those described for FIGS. 2A/B, including having a rigid base 916-2 (which may or may not include lighting sources). A container 900 can be of a size suitable to contain relatively larger glow-in-the-dark items 918, which in the embodiment shown can be a standard recreational ball. An opening 906 can be a drawstring opening, as in the case of FIGS. 2A/B. However, other embodiments can include any of other various suitable openings.

In the embodiment shown, container 900 can include an outside pocket 922, which can contain a power source 910. A power source 910 can connect to the charging light source via a wiring 930. A wiring 930 can extend form an outer surface 931 through a pass-through opening 932, to a charging light source (not shown) within.

FIG. 9A shows container 900 with opening 906 in an open state. FIG. 9B shows container 900 with opening 906′ in a closed state.

As noted herein, according to embodiments, a charging light source can take the form of a string or strip of light sources (e.g., LEDs). FIG. 10 shows a lighting source configuration 1033 for a string/strip charging lighting source according to an embodiment. Lighting source configuration 1033 shows how lighting sources can be arranged on an inner surface of charging chamber. In a lighting source configuration 1033, light sources can be arranged into first direction sections (one shown as 1034) and second direction sections (one shown as 1036).

In one very particular larger bag-type container embodiment (e.g., FIGS. 9A and 9B), a lighting source configuration 1033 can have a total length of about 450 cm, with first direction sections 1034 being about 80 cm and second direction sections 1036 being about 10 cm. In one very particular smaller bag-type container example (e.g., FIG. 8), a total lighting source configuration length can be about 180 to 300 cm. Of course, such dimensions are provided by way of example.

In some embodiments a charging light source can be UV lighting source. In some embodiments, a UV charging light source can emit UV light in the range of 395 to 400 nm. In one particular embodiment, a charging lighting source can be a type 5050 LED UV, IP65, waterproof, 5V lighting strip.

FIG. 11 is a perspective view of a container 1100 according to another embodiment. A container 1100 can be one implementation of that shown in FIGS. 9A/B. Container 1100 can include an outside pocket 1122 for containing a power source (not shown). A power source connector 1120 can connect to a wiring 1130 which can provide power to an internal charging chamber (not shown). FIG. 11 is provided by way of example and should not be construed as limiting.

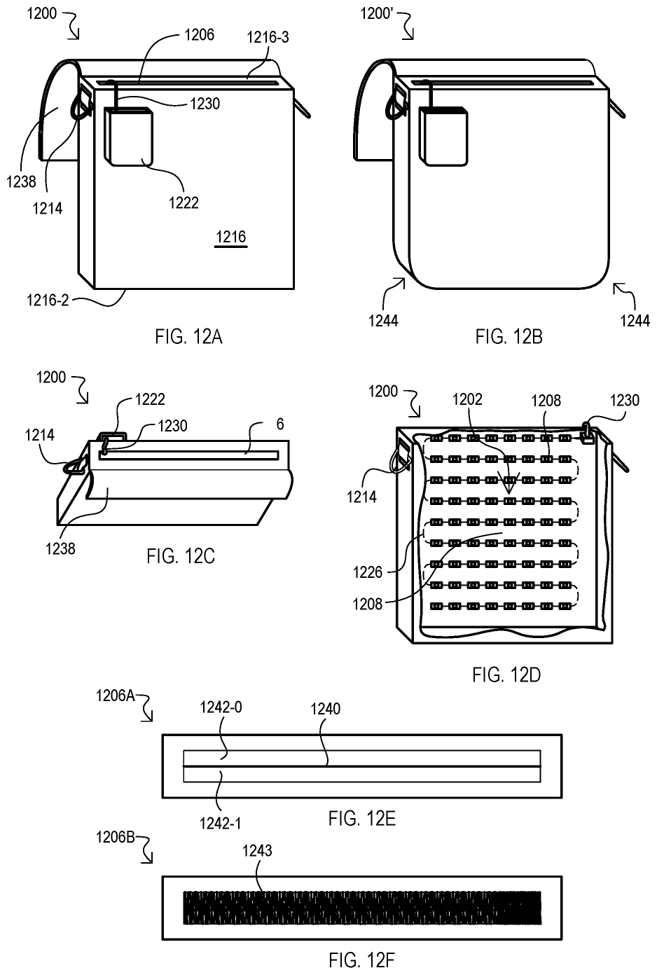

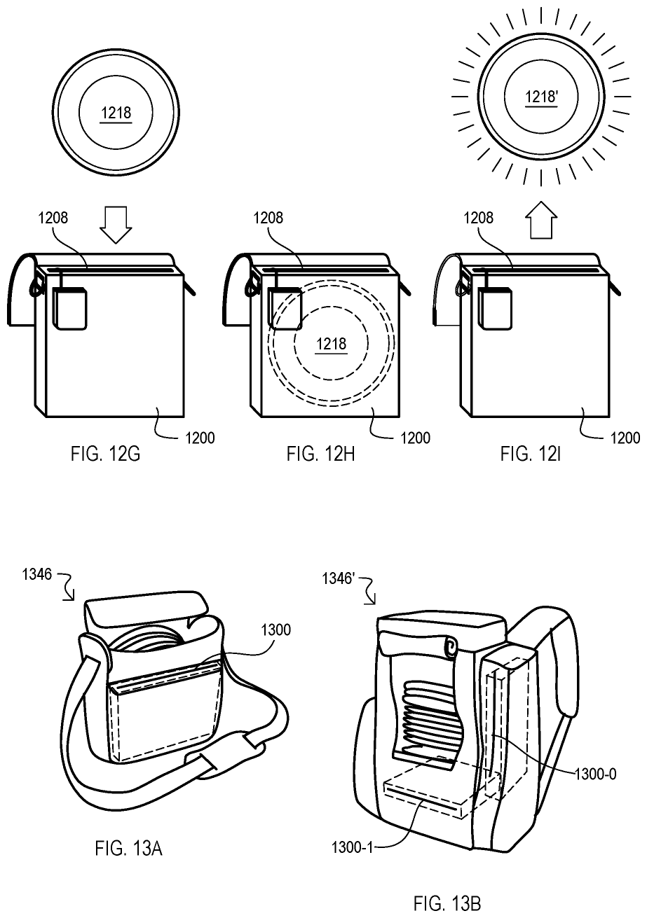

FIGS. 12A to 12I are diagrams showing portable charging containers for glow-in-the-dark flying discs and corresponding methods, according to various embodiments.

FIG. 12A is a diagram of a container 1200 according to an embodiment. A container 1200 can include a body having a base 1216-2, four surrounding sides (one shown as 1216), and a top 1216-3. A top 1216-3 can include an opening 1206, having a slot or slit-like shape for receiving a flying disc.

In the embodiment shown, container 1200 can include an outside pocket 1222 which can hold a power source (not shown). A power source can provide power to a charging light source (not shown) via a wiring 1230. In other embodiments, a power source can be located internal to a body of container 1200. Container 1200 can also include a flap 1238, which can be flipped to cover the opening and pocket 1222. FIG. 12A also shows optional handling members 1214, which can be rings or the like for connection to a strap or other similar carrying item.

FIG. 12B is a diagram of a container 1200′ according to another embodiment. A container 1200′ can include features like those of FIG. 12A. The container 1200′ of FIG. 12B can differ from that of FIG. 12A in that it can have rounded bottom edges 1244. Rounded bottom edges 1244 can enable the container 1200′ to be more easily inserted into other items, such as pockets/openings of a larger bag, as but one example.

FIG. 12C is a top perspective view of a container 1200 like that of FIGS. 12A or 12B. FIG. 12C shows how wiring 1230 can extend through opening 1206 to connect to a charging light source. However, in alternate embodiments, a wiring can extend through a body to a charging light source within the container.

FIG. 12D is a partial cutaway view of a container 1200 like that of FIGS. 12A or 12B. FIG. 12D shows a view with part of a body removed to reveal a charging chamber 1202. A charging chamber 1202 can include an inner surface 1204 with charging light sources (e.g., 1208) connected by wiring 1226. While FIG. 12D shows charging light source 1208 formed on one surface, it is understood the charging light source could continue on any or all other surfaces, including or not including a bottom surface.

FIG. 12E shows an opening 1206A that can be included in embodiments. An opening 1206A can include flexible, lateral blade structures 1242-0/1. Blade structures 1242-0/1 can bend to allow a glow-in-the-dark disc to be inserted into a charging chamber. Once the glow-in-the-dark disc has moved past the blade structures 1242-0/1, the blade structures 1242-0/1 can return to original positions, and thus prevent light from being emitted from the charging chamber or limiting emitted light to a narrow slit 1240.

FIG. 12F shows another opening 1206B that can be included in embodiments. An opening 1206B can include numerous small, individual, narrow members 1243 that can overlap one another. As but one example, members 1243 can take the form of artificial grass, or similar structures. Narrow members 1243 can perform in the same general fashion as lateral blades. As a glow-in-the-dark disc is inserted into opening 1206B, narrow members 1243 can flex, allowing the glow-in-the-dark disc to pass through. Once the glow-in-the-dark disc is within the charging chamber, narrow members 1243 can prevent or limit charging light from being emitted from opening 1206B.

FIGS. 12G to 121 show a portable disc charging container 1200 and operations according to an embodiment. A container 1200 can be one example of those shown in FIGS. 12A to 12F.

Referring to FIG. 12G, a container 1200 can have an opening 1206 that allows a glow-in-the-dark disc 1218 to be inserted into a charging chamber (not shown) formed within. In some embodiments, an opening 1206 can include light blocking members. Thus, even if a charging light source is on, only a little light will be emitted as the glow-in-the-dark disc 1218 is inserted.

Referring to FIG. 12H, once glow-in-the-dark disc 1218 is within a charging chamber, a charging light source, of not already on, can be turned on to charge the glow-in-the-dark disc 1218.

Referring to FIG. 12I, after some time, a charging operation can result in a charged glow-in-the-dark disc 1218′. A user can reach into an opening 1206 and retrieve the now luminous glow-in-the-dark disc 1218′.

While some embodiments can include containers having volumes substantially dedicated to a charging compartment, other embodiments can include charging compartments or chambers as one portion of a larger container or system. FIGS. 13A and 13B show examples of such embodiments.

FIGS. 13A and 13B show disc golf bags 1346 and 1346′. Disc golf bags 1346/1346′ can include various compartments for storing items, including multiple flying discs. However, in addition the golf disc bags 1346/1346′ can include one or more charging compartment according to embodiments described herein or equivalents.

FIG. 13A shows an arrangement in which a glow-in-the-dark item (e.g., glow-in-the-dark flying disc) can be inserted into a vertically oriented charging container 1300 from a top direction.

FIG. 13B shows an arrangement in which a glow-in-the-dark item can be inserted into a vertically oriented charging container 1300-0 from a lateral direction, or alternatively, inserted into a laterally oriented charging container 1300-1 from a lateral direction.

It is understood that any of charging containers 1300, 1300-0/1 shown in FIGS.

13A/B can be separate items (e.g., like those shown in FIGS. 12A/B) positioned within openings of a larger system (e.g., disc golf bag). Alternatively, charging containers 1300, 1300-0/1 can be integrated with a larger system (e.g., are built-in sections of a disc golf bag).

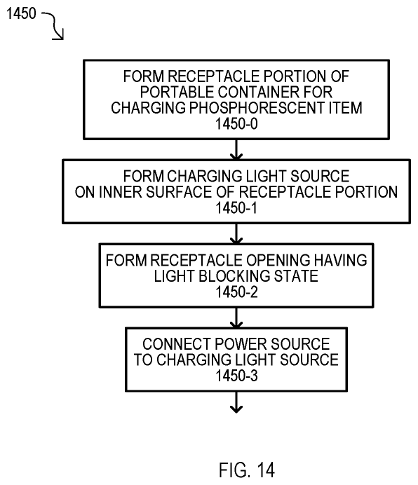

FIG. 14 is a flow diagram of a method 1450 of forming a container according to an embodiment. A method 1450 can include forming a receptacle portion of a portable container for charging a phosphorescent item 1450-0. A charging light source can be formed on an inner surface of a receptacle portion 1450-1. Such an action can include forming the light source before the container body is assembled, or after the container body is assembled (e.g., the charging light source is an insert). A charging light source can take the form of any of those described herein and equivalents.

A method 1450 can also include forming a receptacle opening having a light block state 1450-2. Such an action can include forming an opening that can prevent all or substantially all of the light from escaping the receptacle portion when the charging light source is turned on. A power source can be connected to the charging light source 1450-1. A power source can take the form of any of those described herein, and equivalents.

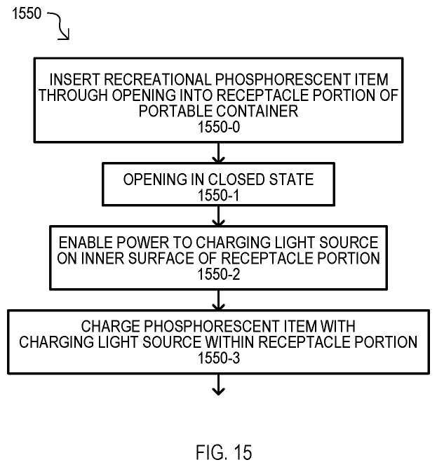

FIG. 15 is a flow diagram of a method 1550 according to another embodiment. A method 1550 can include inserting a recreational phosphorescent item through an opening into a receptacle portion of portable container 1550-0. In some embodiments, this can include enlarging an opening. In other embodiments, an opening includes moving members to enable the insertion of an object. The opening can then be in a closed state 1550-1. Such an action can be automatic or can require a user action on the opening. A closed state of an opening can be any of: a state which prevents a substantial amount of light from a charging light source from being emitted form the opening, or a state that prevents the glow-in-the-dark item(s) from escaping the receptacle portion.

Power for a charging light source on an inner surface of the receptacle portion can be enabled 1550-2. This can result in charging light being applied to the glow-in-the-dark item(s). In some embodiments, charging light can be emitted from multiple directions. In some embodiments, with respect to a plane intersecting an object being charged, charging light can surround the glow-in-the-dark item(s). The phosphorescent item can then be charged with the charging light source 1550-3.

Embodiments herein can provide for portable charging of glow-in-the-dark items. Such charging can be more efficient than conventional approaches, leading to faster charging, and thus more effective use of glow-in-the-dark items. Further, glow-in-the-dark items can be charged in a “hands-free” fashion, enabling a person to travel while a glow-in-the-dark item is being charged.

Embodiments herein can result in a more enjoyable low-light or dark experience, as charging light can be substantially limited to within a charging chamber, and thus not expose users to brightness.

It should be appreciated that in the foregoing description of exemplary embodiments, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim.

Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention. It is also understood that the embodiments of the invention may be practiced in the absence of an element and/or step not specifically disclosed. That is, an inventive feature of the invention can be elimination of an element.

What is claimed is:

1. An apparatus, comprising:
a receptacle portion configured to receive at least one phosphorescent item;
a light source formed on an inner surface of the receptacle portion, and configured to emit a charging light to charge the at least one phosphorescent item to emit latent light;
a power source; and
a switch configured to selectively provide power to the light source; wherein the apparatus is portable by a person.

2. The apparatus of claim 1, wherein the receptacle portion comprises
a rigid base member, and
a surrounding wall formed of a flexible material attached to the rigid base member.

3. The apparatus of claim 1, wherein the light source comprises at least one light emitting diode (LED).

4. The apparatus of claim 3, wherein the light source comprises at least one string of LEDs arranged on the inner surface to luminate the phosphorescent item from more than one direction within the receptable portion.

5. The apparatus of claim 1, wherein the light source comprises at least one ultraviolet light source.

6. The apparatus of claim 1, further including:
a power supply receiver formed on an outer surface of the apparatus and configured to receive a power source for the light source; and
a power connection that extends from the light source to the outer surface of the apparatus.

7. The apparatus of claim 1, further including an opening through which the phosphorescent item is placed into the receptacle portion, the opening having a light blocking state in which light in the receptacle portion is substantially prevented from being emitted from the apparatus when the light source is emitting light.

8. The apparatus of claim 7 wherein the opening comprises a flexible material having a contractable hole formed therein, the light blocking state being when the hole is contracted from a larger size to a smaller size.

9. The apparatus of claim 7, wherein the opening comprises a flexible material that bends from an initial position to allow the phosphorescent item to enter the receptacle portion and returns to the initial position after the phosphorescent item is in the receptacle portion, the light blocking state being the initial position.

10. The apparatus of claim 1, wherein the receptacle portion is configured to receive a phosphorescent item selected from the group consisting of: a pet toy, a ball, and a flying disc.

11. A portable container for a charging at least one phosphorescent item, comprising:
a body that includes
an outer surface,
an inner surface having a light source formed thereon, and
an opening configured to accept the at least one phosphorescent item; wherein
the light source is configured to emit a charging light to enable the phosphorescent item to emit latent light.

12. The portable container of claim 11, wherein the light source comprises ultraviolet light emitting diodes.

13. The portable container of claim 11, further including a power supply connected to provide power to the light source.

14. The portable container of claim 13, further including a switch accessible from an outer surface of the portable container for enabling or disabling power to the light source.

15. The portable container of claim 11, further including a carrying attachment that enables the container to be carried by a person on a part of the body.

16. The portable container of claim 15, the carrying member includes at least one strap.

17. The portable container of claim 11, wherein the body includes a closable bag.

18. The portable container of claim 11, wherein the portable container comprises a glow-in-the-dark ball container.

19. The portable container of claim 11, wherein the opening has an elongated straight shape configured to receive a flying disk

20. The portable container of claim 19, wherein the portable container comprises a disc golf bag at least one region configured to hold multiple flying discs and a charging compartment with the light source separate from the at least one region.
